(19) United States
(12) Patent Application Publication
(10) Pub. No.: US 2009/0183857 A1
(43) Pub. Date: Jul. 23, 2009

(54) Turbulator for a heat exchanger tube, and method of manufacture

(76) Inventors: David Bland Pierce, Warwick (GB); Gerrard M. Pierce, Coventry (GB); Paul L. Pierce, Tamworth (GB); James Niekrasz, Coventry (GB)

Correspondence Address: INTELLECTUAL PROPERTY / TECHNOLOGY LAW, PO BOX 14329, RESEARCH TRIANGLE PARK, NC, 27709, US

(21) Appl. No.: 12/288,283

(22) Filed: Oct. 17, 2008

(30) Foreign Application Priority Data
Oct. 19, 2007 (GB) 0720627.9

(51) Int. Cl. F28F 13/12; B23P 15/26

(52) U.S. Cl. 165/109.1; 29/890.053

(57) ABSTRACT

A turbulator for a heat exchanger tube, and a method of manufacturing the heat exchanger tube. The turbulator comprises a mesh, ideally a woven mesh, of material, ideally metallic wires. The mesh is formed into corrugations of a size substantially to fill the heat exchanger tube. The method comprises the steps of: making a mesh of material; forming the mesh into corrugations; and fitting the corrugated mesh into the heat exchanger tube so that the corrugated mesh substantially fills the heat exchanger tube for some or all of its length. The turbulator and method are particularly suited to flat heat exchanger tubes.

### CROSS-REFERENCE TO RELATED APPLICATION

This application claims priority under 35 U.S.C. §119 of United Kingdom Patent Application No. 0720627.9 filed Oct. 19, 2007. The disclosure of such United Kingdom patent application is hereby incorporated herein by reference in its entirety, for all purposes.

1. Field of the Invention

This invention relates to a turbulator for a heat exchanger tube, and to a method of manufacturing the heat exchanger tube.

2. Background of the Invention

Often it is necessary to cool a working fluid, and it is known for this purpose to use a heat exchanger. Heat exchangers often comprise one or more metallic tubes suspended between two tube plates. Usually, the working fluid to be cooled, which may for example be water or oil, flows through the tubes, whilst the coolant passes around and between those tubes, the working fluid giving up its latent heat to the tubes and thus to the coolant.

The effective surface area of a tube can be enlarged in order to increase the heat transfer, as by the addition of one or more extended surface members or fins in thermal contact with the outer surface of the tube. Such finned tubes are particularly useful if the coolant has a low viscosity, and if the coolant is a gas, such as air.

In addition, the heat exchange can be increased by the use of a turbulator within the tube, the turbulator acting to disturb any laminar flow of the working fluid within the tube, or in other words to induce turbulence into the working fluid as it flows along the heat exchanger tube. Thus, it is recognised that the presence of laminar flow in the working fluid decreases the heat exchange as cooler working fluid remains adjacent to the tube wall whilst hotter working fluid flows along the centre of the tube and gives up less of its heat energy to the tube wall than would be the case with turbulent flow. This is a particular problem when the working fluid is oil, as the viscosity of oil changes significantly over the temperature range typically encountered in the heat exchanger, with the cooler oil forming a substantially stationary surface layer upon the inside of the tube, the stationary layer acting as a heat insulator and reducing the heat transferred from the hotter oil flowing along the centre of the tube.

### DESCRIPTION OF THE PRIOR ART

There are several types of turbulator in present use. One type comprise a wire wound around a central shaft, the wire being wound into a shape which has the appearance of the outline of a series of flower petals surrounding the central shaft. The series of “petals” surrounds the central shaft and spans the length of the central shaft in a substantial helical pattern. It is arranged that the “petals” are offset along the length of the central shaft, i.e. a petal is out of alignment with its longitudinal neighbors, so that a continuous path for the working fluid along the tube is avoided.

Another turbulator comprises a strip of metallic tape having a width similar to the diameter of the tube, the tape being wound into a helix. When the tape is inserted into the tube the working fluid is forced to undertake a helical flow path along the tube.

Both of these turbulators are limited to use in heat exchanger tubes having a circular cross-section. Not all heat exchanger tubes fulfill that criterion, and in particular oval or flat tubes are known to provide better performance when the coolant is air, for example in the radiators and oil coolers of motor vehicles. For the avoidance of doubt, flat tubes as used in heat exchanger applications have a cross-sectional shape comprising two parallel long sides joined by two curved short sides, and therefore have the cross-sectional appearance of a severely flattened circle.

A turbulator for flat tubes is also known, and comprises a sheet of metal which has a pattern of slits formed therethrough, the slitted sheet then being pressed so that the slitted parts form many rows of corrugations. In use, the rows of corrugations run perpendicular to the longitudinal axis of the tube, and each row is offset from its neighbors. Despite the offsetting of the neighboring rows, however, a substantially direct path through the turbulator remains for the working fluid, and so this turbulator does not maximize the heat exchange which is available, particularly when the working fluid is oil. In addition, the requirement to form slits into the sheet of metal, and subsequently to press the metal into rows of corrugations, limits the materials which can be used for the turbulator.

### SUMMARY OF THE INVENTION

It is the object of the present invention to provide a turbulator for a heat exchanger tube, and in particular for a flat heat exchanger tube, which avoids or reduces the disadvantages of the prior art turbulators described above.

According to the invention, there is provided a turbulator for a heat exchanger tube comprising a mesh of material, the mesh of material being formed into corrugations. The corrugated mesh will ideally substantially fill the heat exchanger tube for all of part of its length.

Preferably the mesh is of a heat conductive material. Whilst it is preferable for the mesh to be heat conductive so as to facilitate the transfer of heat from the working fluid to the tube, it has been discovered that this is not always necessary, particularly with flat tubes, and a turbulator of a thermally insulating material can increase the heat exchange merely by inducing turbulence into the fluid.

A mesh material can be made from many suitable materials and so there are few limitations upon the material from which the turbulator can be made. Ideally the mesh material is a metal, and most of the metals which might be suitable for the use as a turbulator in heat exchanger applications can be formed into wires and subsequently formed into a mesh. Alternatively the mesh material could be moulded or sintered plastic for example, a suitable sintered nylon material being produced by selective laser sintering.

Preferably, the mesh is woven from wires or strands of the material. Preferably also, respective wires or strands of the woven material are arranged substantially perpendicular to each other. The present invention takes advantage of the fact that weaving with substantially perpendicular wires or strands is well established technology, and there are many manufacturers of woven metal wire mesh for example.

Ideally the corrugations are substantially sinusoidal. Sinusoidal corrugations are not essential, however, and corrugations of other forms can be used. However, curved corrugations are preferred, i.e. it is not presently preferred to use rectangular corrugations.

Preferably, the axis of the corrugations, i.e. that axis along which the distance between successive peaks of the corrugations is minimized, is at an acute angle to the axes of the mesh, i.e. at an acute angle to the longitudinal axes of the wires forming the mesh. Angling the corrugations relative to the mesh in this way reduces the likelihood that there is a substantially straight path through the turbulator.

There is also provided a heat exchanger tube fitted with a turbulator as defined herein.

Desirably, the turbulator is a sliding fit within the tube. A sliding fit is preferred so as to minimize the likelihood of the turbulator becoming distorted or damaged during insertion into the tube.

Alternatively (or additionally), the turbulator can include a substantially linear wire which is used to pull the turbulator into the heat exchanger tube. The substantially linear wire is preferably secured to the mesh at multiple positions along the length of the mesh, so that as the substantially linear wire is pulled through the tube the mesh is pulled thereby.

In certain embodiments the corrugated mesh of material is resilient, so that the corrugations in the mesh can be significantly flattened during insertion into the heat exchanger tube, and once inserted the corrugations can move into tight (or tighter) contact with the tube wall. This is particularly advantageous with heat conductive mesh as a tighter contact with the tube wall will usually lead to an increase the heat exchange capability therebetween.

### BRIEF DESCRIPTION OF THE PREFERRED EMBODIMENTS

The invention will now be described in more detail, by way of example, with reference to the accompanying drawings, in which:

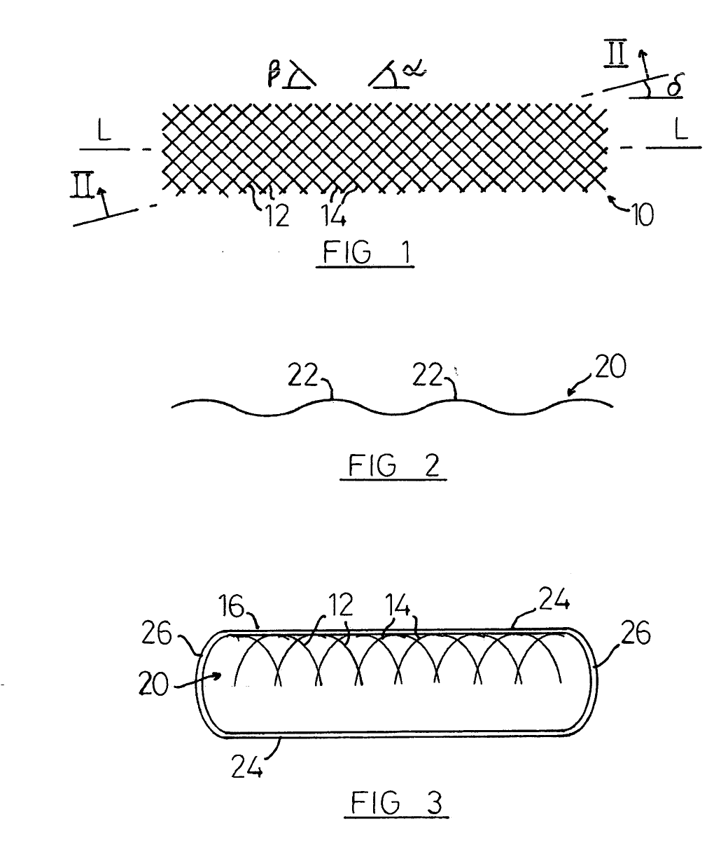

FIG. 1 shows a plan view of a mesh material prior to corrugating;

FIG. 2 shows a sectional view along the line II-II of FIG. 1, after the mesh material has been corrugated; and

FIG. 3 shows a representation of a heat exchanger tube according to the invention, in cross-section.

### DETAILED DESCRIPTION

The mesh material 10 of FIG. 1 is made of metal, and is formed from a first set of wires 12 and a second set of wires 14, the wires in the set of wires 12 all being substantially parallel with each other, as are the wires in the set of wires 14. The wires 12, 14 are interlaced or woven in known fashion.

The mesh 10 is formed as a strip having a longitudinal axis L which will be aligned with the longitudinal axis of the heat exchanger tube 16 (FIG. 3) when fitted. The wires 12 are arranged at an angle a to the axis L, and the wires 14 are arranged at an angle β to the axis L.

In this embodiment both of the angles α and β are 45°, so that the wires 12 and 14 are perpendicular to one another. In another embodiment the angle α is 0° and the angle β is 90°, and in yet other embodiments the angles fall between these values. In yet other embodiments the wires 12 and 14 are not perpendicular, the angles α and β being chosen to suit a particular material from which the mesh is made, or to meet a desired manufacturing or performance criterion.

The wires 12 and 14 in this embodiment are of aluminum with a circular cross-section having a diameter of 0.1 mm and a mesh pitch of 1 mm. Such a mesh material is available from Potter & Soar Limited, of Beaumont Road, Banbury, OX16 ISD, UK, for example. The wires 12 and 14 can be coated with a protective material such as epoxy, which will reduce the tendency of the wires to break during corrugation or during insertion into the heat exchanger tube 16, it being recognised that small fragments of wire which break off from the mesh 10 could interfere with other components within the circuit of the working fluid.

Notwithstanding the use of woven wire in the preferred embodiment described, the present invention could alternatively utilize a mesh formed of wires which are bonded at their junctions, the bonding perhaps being achieved by a coating material which serves both to bond the wires together and also to protect the wires during corrugation and insertion into the tube.

Prior to insertion into the tube 16 the mesh 10 is corrugated into a turbulator 20 (FIG. 2). The corrugations (which are shown in FIG. 2) are preferably achieved by passing the strip of mesh 10 through a set of corrugating rollers (not shown). The form of the rollers, and the resulting wavelength, amplitude and orientation of the corrugations, can be determined to suit a particular application, but it is presently preferred that the corrugations be curved rather than rectangular, so as to avoid the need to form sharp corners in the wires 12, 14. Corrugating rollers which form sinusoidal corrugations for example are readily available.

Importantly, the axis of the corrugations (i.e. the shortest line joining successive peaks 22 (or successive troughs) of the corrugations, should desirably not be parallel with the axis of the wires 12 or 14. If the axis of the corrugations is parallel to the axis of the wires 12 or 14 it is possible that the working fluid would be presented with one or more substantially linear paths through the turbulator 20, and this should be avoided, especially if the heat exchanger tube is to be used in a heat exchanger in which the working fluid is oil.

In this embodiment the axis of the corrugations lies along the line II-II, at an angle δ to the longitudinal axis L, where the angle δ differs from the angles α and β preferably by at least 15°. In another embodiment (in which the angles α and β are 45°) the axis of the corrugations is parallel to the longitudinal axis L. In all embodiments, the peaks and troughs of the corrugations should run generally across the mesh rather than generally along the mesh, i.e. the angle δ is preferably significantly less than 90°, and ideally less than 45°, so that a linear path through the turbulator 20 (i.e. along a trough) is not available.

The turbulator 20 is intended to substantially fill the heat exchanger tube 16, so that there are preferably no direct paths for the working fluid between the turbulator 20 and the tube wall. In common with other flat heat exchanger tubes, the tube 16 in cross-sectional view as seen in FIG. 3 has two parallel long walls 24 and two curved short walls 26.

It will be recognised that it may not be possible to form the mesh 10 to completely fill the cross-sectional area of the tube 16, and there may be small gaps present between the turbulator 20 and the tube wall, for example adjacent to the curved short walls 26. That is not too disadvantageous, however, as the resulting direct path for the working fluid lies directly adjacent to the tube wall so that the working fluid will nevertheless give up much of its heat to the tube wall. Alternatively, the form of the corrugating rollers can be chosen to form the longitudinal edges of the turbulator into a curved form closely matching the curved shape of the short walls 26, so that the presence of gaps is reduced or avoided.

It will be understood that FIG. 3 represents a cross-section very close to, and viewed towards, the end of the heat exchanger tube 16, so that only around a half of one corrugation of the mesh 10 is visible for ease of understanding. In an end view of an actual heat exchanger tube made according to the invention, the tube would be totally (or at least substantially) filled by the turbulator 20.

When the corrugations are formed in the mesh 10, it is arranged that the amplitude closely matches the distance between the tube walls 24, so that substantially no gap lies adjacent to the tube walls 24. However, it will be appreciated that in these circumstances there will be a frictional resistance to the passage of the turbulator 20 along the tube 16. If the frictional resistance is too great the turbulator 20 may become distorted or damaged, leading to a larger or smaller pressure drop within the tube 16, and a better or worse heat exchange performance, than was expected. Accordingly, it may be preferable to make the amplitude of the corrugations very slightly smaller than the distance between the tube walls 24, so that the turbulator 20 can be slid easily into the tube 16 without the likelihood of distortion or damage. Whilst that would increase the likelihood of a gap between the turbulator 20 and one or both of the tube walls 24, which gap would provide a direct path for working fluid through the tube 16, once again that is not too disadvantageous because that direct path lies immediately adjacent to the tube wall 24.

In a preferred embodiment the turbulator 20 is sufficiently resilient (because of the material from which it is made and/or the way the corrugations are formed) to allow the corrugations to be flattened to an amplitude smaller than the distance between the tube walls 24 as the turbulator 20 is pulled through the tube 16, and when released the amplitude will increase so that the turbulator 20 engages both of the tube walls 24.

In another preferred embodiment a substantially linear fitting wire (not shown) is secured along the turbulator, usefully being secured at each of the peaks 22 of the corrugated mesh. The fitting wire is provided so that it can be pulled through the tube 16 and thereby pull the turbulator. Because the fitting wire is secured along the corrugated mesh, the tensile force upon the fitting wire as the turbulator is pulled through the tube 16 is spread out over the length of the turbulator so reducing the likelihood of any part of the mesh becoming damaged or distorted.

The fitting wire may be bonded to the peaks of the corrugations, suitably by an adhesive or the like which also acts to coat and protect the wires of the turbulator.

In other embodiments the mesh is non-metallic, and can for example comprise a moulded mesh of plastics material, or a sintered mesh from a suitable base material such as nylon.

1. A turbulator for a heat exchanger tube comprising a mesh of material, the mesh of material being formed into corrugations.

2. A turbulator as claimed in claim 1 in which the mesh is of heat conductive material.

3. The turbulator as claimed in claim 1 in which the mesh is woven from strands of the material.

4. The turbulator as claimed in claim 3 having a longitudinal axis, in which a first set of strands lies at a first angle to the longitudinal axis, and a second set of strands lies at a second angle to the longitudinal axis.

5. The turbulator as claimed in claim 4 in which the first set of strands is substantially perpendicular to the second set of strands.

6. The turbulator as claimed in claim 5 in which the first angle is around 45° and the second angle is around 135°.

7. The turbulator as claimed in claim 4 having a corrugation axis, the corrugation axis being at an angle to the longitudinal axis.

8. The turbulator as claimed in claim 7 in which the angle of the corrugation axis differs from the first angle and the second angle.

9. The turbulator as claimed in claim 8 in which the angle of the corrugation axis differs from the first angle and from the second angle by at least 15°.

10. The turbulator as claimed in claim 7 in which the angle between the corrugation axis and the longitudinal axis is less than 60°.

11. The turbulator as claimed in claim 7 in which the angle between the corrugation axis and the longitudinal axis is less than 45°.

12. The turbulator as claimed in claim 7 in which the angle between the corrugation axis and the longitudinal axis is less than 30°.

13. The turbulator as claimed in claim 1 in which the corrugations are curved.

14. The turbulator as claimed in claim 13 in which the corrugations are substantially sinusoidal.

15. The turbulator as claimed in claim 1 in which the mesh of material is resilient.

16. A turbulator as claimed in claim 1 which includes a substantially linear strand connected to the mesh.

17. A heat exchanger tube fitted with a turbulator as claimed in claim 1, the turbulator substantially filling the heat exchanger tube along at least part of its length.

18. A heat exchanger tube as claimed in claim 17 in which the turbulator is a sliding fit within the tube.

19. A heat exchanger tube as claimed in claim 17 in which the tube is flat.

20. A method of making a heat exchanger tube comprising the steps of:
making a corrugated mesh of material, and
fitting the corrugated mesh into the heat exchanger tube so that the corrugated mesh substantially fills the heat exchanger tube for some or all of its length.
